(19) United States
(12) Patent Application Publication
(10) Pub. No.: US 2017/0161009 A1
(43) Pub. Date: Jun. 8, 2017

(54) VEHICULAR DISPLAY DEVICE

(71) Applicant: Yazaki Corporation, Tokyo (JP)

(72) Inventors: Takuma OGISU, Susono-shi (JP); Tetsuya SUGIYAMA, Susono-shi (JP); Yoshiyuki FURUYA, Susono-shi (JP)

(73) Assignee: Yazaki Corporation, Tokyo (JP)

(21) Appl. No.: 15/440,291

(22) Filed: Feb. 23, 2017

Related U.S. Application Data
(63) Continuation of application No. PCT/JP2015/076241, filed on Sep. 16, 2015.

(30) Foreign Application Priority Data
Sep. 29, 2014 (JP) 2014-198754
Sep. 29, 2014 (JP) 2014-198755
Sep. 29, 2014 (JP) 2014-198756

(51) Int. Cl. G06F 3/14; G02B 27/01; B60K 35/00

(52) U.S. Cl. CPC G06F 3/1446; B60K 35/00; G02B 27/0101; B60K 2350/1072; G06T 19/006

(57) ABSTRACT

There is provided an HUD main body for displaying front display information formed as front virtual image on a line of sight of a passenger, lower display information formed as lower virtual image below the front virtual image, and upper display information formed as upper virtual image above the front virtual image. The lower virtual image and the upper virtual image are formed to be closer to the passenger as they are farther away from the front virtual image, or toward the lower side and the upper side, respectively.

### TECHNICAL FIELD

The present invention relates to a vehicle display device mounted on a vehicle.

### BACKGROUND ART

There is well known a display device called headup display which embeds a display unit including a display for issuing driving information such as traveling speed and an optical member such as lens for forming an image of the driving information issued from the display as display image with desired size at a desired position in a dashboard of a vehicle and irradiates the driving information issued from the display on the windshield thereby to form the display image to be superimposed on the scene at the desired position in front of the vehicle.

It has been proposed that the headup display is provided with a plurality of light emitters arranged along a path of a display light from the display (Patent Literature 1). Virtual images of guide lights from the light emitters are sequentially lit from the rear side of the vehicle toward the front side. Thereby, the virtual images of the guide lights are visually confirmed by the driver via the virtual image of the display light of the display, thereby enabling a display with a sense of depth.

However, there has been a first problem that expressing the sense of depth by the guide lights only is not enough.

Further, for example, Patent Literature 2 describes that when guidance information or the like of a navigation device is displayed while a speed is being displayed, the incoming guidance information is largely displayed thereby to enhance visibility of the guidance information.

However, with the display method described in Patent Literature 2, the guidance information is merely indicated by an arrow, the front-back direction information of the vehicle was hard to be known, and thus a route to be guided cannot be intuitively recognized.

### CITATION LIST

### Patent Literature

Patent Literature 1: JP 2011-128450 A

Patent Literature 2: JP 2003-345334 A

### SUMMARY OF INVENTION

### Technical Problem

It is therefore a first object of the present invention to provide a vehicle display device capable of conducting a display with a sense of depth.

It is a second object of the present invention to provide a vehicle display device capable of guiding a route intuitive and easy to understand in terms of the above problem.

A first aspect of provided for solving the first object is a vehicle display device including: a display unit for displaying front display information formed as front virtual image on a line of sight of a passenger and surrounding display information formed as surrounding virtual image at least partially around the front virtual image, wherein the surrounding virtual image is formed to be closer to the passenger as it is farther away from the front virtual image.

A second aspect is the vehicle display device according to the first aspect, wherein the surrounding display information is lower display information formed as lower virtual image below the front virtual image or upper display information formed as upper virtual image above the front virtual image, and the lower virtual image is formed to be closer to the passenger toward the lower side, or the upper virtual image is formed to be closer to the passenger toward the upper side.

A third aspect is the vehicle display device according to the second aspect, wherein the display unit comprises a front display for displaying the front display information and a downward-faced display for displaying the lower display information or an upward-faced display for displaying the upper display information, and the downward-faced display or the upward-faced display is arranged above or below the front display.

A fourth aspect is the vehicle display device according to any one of the first to third aspects, wherein the surrounding display information is right display information formed as right virtual image on the right side of the front virtual image or left display information formed as left virtual image on the left side of the front virtual image, and the right virtual image is formed to be closer to the passenger toward the right side, or the left virtual image is formed to be closer to the passenger toward the left side.

A fifth aspects is the vehicle display device according to the fourth aspect, wherein the display unit comprises a front display for displaying the front display information and a right display for displaying the right display information or a left display for displaying the left display information, and

the right display or the left display is arranged on the right side or the left side of the front display.

### Solution to Problem

A sixth aspect provided for solving the second object is a vehicle display device including a display unit for displaying first guidance information as first virtual image on a line of sight of an observer and second guidance information as second virtual image below the first guidance information, wherein the second virtual image is closer to the observer downward, the first guidance information is farther away from the observer than the second guidance information, and the first guidance information and the second guidance information are displayed to be continuous.

A seventh aspect is characterized in that the display is gradually emphasized from the second guidance information toward the first guidance information according to the sixth aspect.

An eighth aspect is characterized in that the display unit displays third guidance information as third virtual image on the right and left sides of the first guidance information, and the third guidance information is displayed on the right side of the first guidance information when the first guidance information is for right turn of the vehicle, and is displayed on the left side of the first guidance information when the first guidance information is for left turn of the vehicle according to the sixth or seventh aspect.

A ninth aspect provided for solving the first object is a vehicle display device arranged in an instrument panel of a vehicle and directed for forming a virtual image beyond a windshield, wherein the virtual image is a main image displayed to face a passenger and a sub-image adjacent to the main image at one end and closer to the passenger at the other end than the end, the vehicle display device including a display for forming the main image, and a projector and a non-planar screen for forming the sub-image.

A 10th aspect is characterized in that the screen is a reflective screen according to the ninth aspect.

An 11th aspect is characterized in that the screen is a transmissive screen according to the ninth aspect.

A 12th aspect is characterized in that the screen has a curved part according to any one of the ninth to 11th aspects.

A 13th aspect is characterized in that the screen has a plurality of faces different in distance from the projector according to any one of the ninth to 12th aspects.

A 14th aspect is characterized in that the screen is formed in a tubular shape according to any one of the ninth to 13th aspects.

### Advantageous Effects of Invention

As described above, according to the invention of the first aspect, a surrounding virtual image displayed at least partially around the front virtual image is formed to be closer to the passenger as it is farther away from the front virtual image. Thereby, a display with a sense of depth can be conducted.

According to the second aspect, the lower virtual image displayed below the front virtual image is formed to be closer to the passenger downward, or the upper virtual image displayed above the front virtual image is formed to be closer to the passenger upward. Thereby, a display with a sense of depth can be conducted.

According to the third aspect, the downward-faced display or the upward-faced display is arranged above or below the front display thereby to easily display the lower virtual image or the upper virtual image.

According to the fourth aspect, the right virtual image displayed on the right side of the front virtual image is formed to be closer to the passenger rightward, or the left virtual image displayed on the left side of the front virtual image is formed to be closer to the passenger leftward. Thereby, a display with a sense of depth can be conducted.

According to the fifth aspect, the right display or the left display is arranged on the right side or the left side of the front display thereby to easily display the right virtual image or the left virtual image.

According to the invention of the sixth aspect, the second virtual image is closer to the observer downward, and thus the second guidance information can be displayed to cause the observer to feel a sense of depth. Further, the first guidance information is farther away from the observer than the second guidance information, and thus information in the front-back direction of the vehicle can be displayed in the second guidance information, for example. Further, the first guidance information and the second guidance information are displayed to be continuous, thereby guiding a route intuitive and easy to understand.

According to the seventh aspect, the display is gradually emphasized from the second guidance information toward the first guidance information, thereby conducting guidance with a change in display depending on a position of the vehicle, for example.

According to the eighth aspect, the third guidance information is displayed on the right side of the first guidance information when the first guidance information is for right turn of the vehicle, and is displayed on the left side of the first guidance information when the first guidance information is for left turn of the vehicle, thereby emphasizing left turn or right turn guidance.

According to the ninth aspect, one end of the sub-image is adjacent to the main image and the other end is closer to the passenger, and thus the main image is positioned farther away from the observer than the sub-image, and the main image and the sub-image are combined to be sterically displayed. Further, the sub-image is formed by the projector and the non-planar screen thereby to be formed in a non-planar shape, and the sub-image and the main image are combined thereby to further enhance a sense of three-dimensionality than a combination with a planar sub-image. At this time, the screen can be more easily formed in a non-planar shape than the display.

According to the 10th aspect, the configuration of the screen can be simplified.

According to the 11th aspect, the projector can be arranged opposite to the windshield (or the reflective member) across the screen, thereby simplifying the configuration of the windshield (or the reflective member) around the display.

According to the 12th aspect, the screen is formed with a curved part such that the sub-image at one end is concave-curved as viewed from the main image, and thus the main image and the sub-image are smoothly connected, thereby enhancing a sense of three-dimensionality and displaying an image with a sense of unity.

According to the 13th aspect, the screen has a plurality of faces or the screen is formed in a stepped manner, and thus the sub-image is displayed with a plurality of display faces. The display faces are arranged in the front-back direction of the vehicle, and the faces of the screen are set such that the display faces closer to one end are positioned to be closer to the main image in the crossing direction with the front-back direction, and thus the sub-image is visually confirmed to be closer to the main image in the crossing direction toward the front side, thereby enhancing a sense of three-dimensionality.

According to the 14th aspect, the image is displayed to be surrounded and the main image is emphasized, thereby enhancing a sense of three-dimensionality.

### BRIEF DESCRIPTION OF DRAWINGS

FIG. 1 is a configuration diagram of a headup display device according to a first embodiment of the present invention.

FIG. 2 is an enlarged view of a front display, a downward-faced display, an upward-faced display, and an aspherical mirror illustrated in FIG. 1.

FIGS. 3A to 3D are explanatory diagrams of exemplary video display in the headup display device illustrated in FIG. 1.

FIG. 4 is an explanatory diagram of exemplary video display in the headup display device illustrated in FIG. 1.

FIG. 5 is an explanatory diagram of exemplary video display in the headup display device illustrated in FIG. 1.

FIG. 6 is an explanatory diagram of exemplary video display in the headup display device illustrated in FIG. 1.

FIG. 7 is a configuration diagram of the headup display device according to a second embodiment of the present invention.

FIG. 8 is an enlarged view of the front display, a right display, a left display, and the aspherical mirror illustrated in FIG. 7.

FIG. 9A is an explanatory diagram for explaining a situation around a self-vehicle during lane change, and FIGS. 9B to 9E are explanatory diagrams of exemplary video display in the headup display device illustrated in FIG. 7 in the situation of FIG. 9A.

FIG. 10A is an explanatory diagram for explaining deviation of lane, FIG. 10B is an explanatory diagram for explaining a situation in which a pedestrian is on the right side, and FIG. 10C is an explanatory diagram of exemplary video display in the headup display device illustrated in FIG. 7 in the situation of FIG. 10A or 10B.

FIG. 11 is an explanatory diagram of exemplary video display in the headup display device illustrated in FIG. 7.

FIG. 12 is an explanatory diagram of exemplary video display in the headup display device according to another embodiment.

FIG. 13 is a configuration diagram of the headup display device according to a third embodiment of the present invention.

FIGS. 14A and 14B are explanatory diagrams of exemplary video display in the headup display device illustrated in FIG. 13.

FIG. 15 is an explanatory diagram of a relationship between first guidance information and second guidance information illustrated in FIG. 13.

FIG. 16 is an explanatory diagram of other exemplary video display in the headup display device illustrated in FIG. 13.

FIG. 17 is an explanatory diagram of other exemplary video display in the headup display device illustrated in FIG. 13.

FIG. 18 is a configuration diagram of the headup display device according to a fourth embodiment of the present invention.

FIG. 19A and FIG. 19B are explanatory diagrams of exemplary video display in the headup display device illustrated in FIG. 18.

FIG. 20 is an explanatory diagram of exemplary video display in the headup display device illustrated in FIG. 18.

FIG. 21 is an explanatory diagram of other exemplary video display in the headup display device illustrated in FIG. 18.

FIG. 22 is a side view illustrating a vehicle display device according to a fifth embodiment of the present invention.

FIG. 23 is a front view illustrating an exemplary image displayed by the vehicle display device of FIG. 22.

FIG. 24 is a side view illustrating a vehicle display device according to a sixth embodiment of the present invention.

FIGS. 25A and 25B area side view and a top view illustrating a vehicle display device according to a seventh embodiment of the present invention, respectively.

FIGS. 26A to 26C are front views illustrating an exemplary image displayed by the vehicle display device of FIGS. 25A and 25B.

FIG. 27 is a top view illustrating a vehicle display device according to an eighth embodiment of the present invention.

FIG. 28 is a top view illustrating a vehicle display device according to a ninth embodiment of the present invention.

### DESCRIPTION OF EMBODIMENTS

### First Embodiment

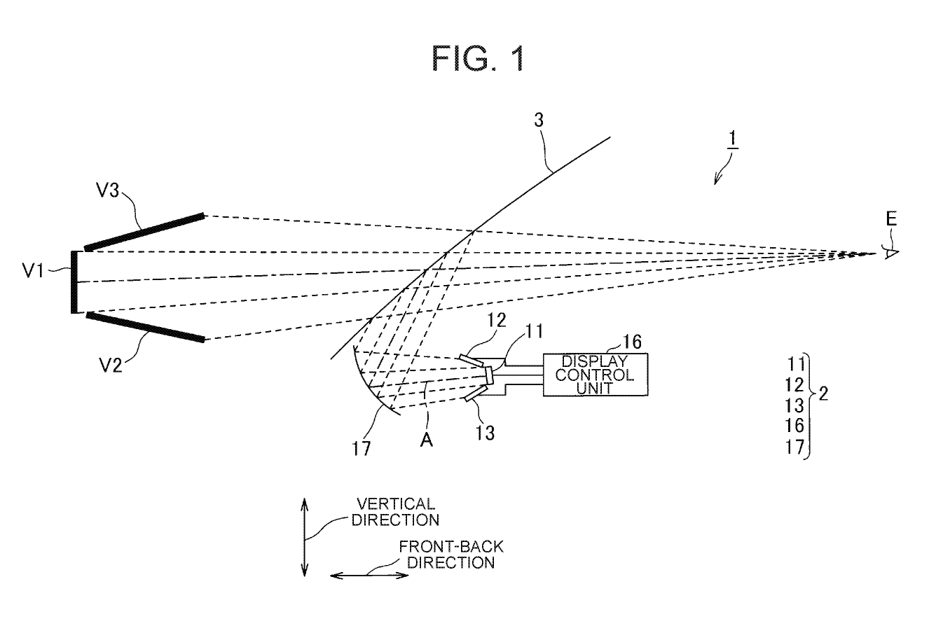

A first embodiment of the present invention will be described below with reference to FIG. 1 to FIG. 6. FIG. 1 is a configuration diagram of a headup display device as vehicle display device according to the first embodiment of the present invention.

A headup display (HUD) device 1 according to the first embodiment of the present invention is mounted on a vehicle such as automobile, and includes an HUD main body 2 and a windshield 3 as illustrated in FIG. 1. The front-back direction and the vertical direction of the vehicle according to the present embodiment are as indicated in FIG. 1.

The HUD main body 2 as display unit has a front display 11, a downward-faced display 12, an upward-faced display 13, a display control unit 16, and an aspherical mirror 17. The HUD main body 2 is housed near the lower end of the windshield 3 in an instrument panel of the vehicle. Videos are projected from the front display 11, the downward-faced display 12, and the upward-faced display 13 toward the windshield 3, and a scene in front of the vehicle, which is visually confirmed via the windshield 3, is superimposed on a front virtual image V1, a lower virtual image V2 (=surrounding virtual image), and an upper virtual image V3 (=surrounding virtual image) which are reflected on the windshield 3 and visually confirmed by a passenger. Sign E in FIG. 1 indicates an eye point at a position of the eyes of the passenger.

The front display 11 is configured of TFTLCD (TFT liquid crystal display device), for example, and displays thereon a video displayed as the front virtual image V1 on the basis of a video signal, a synchronization signal, or the like input from the display control unit 16. The front display 11 is arranged to face the aspherical mirror 17 as a reflective member. A indicates an optical axis of the front display 11.

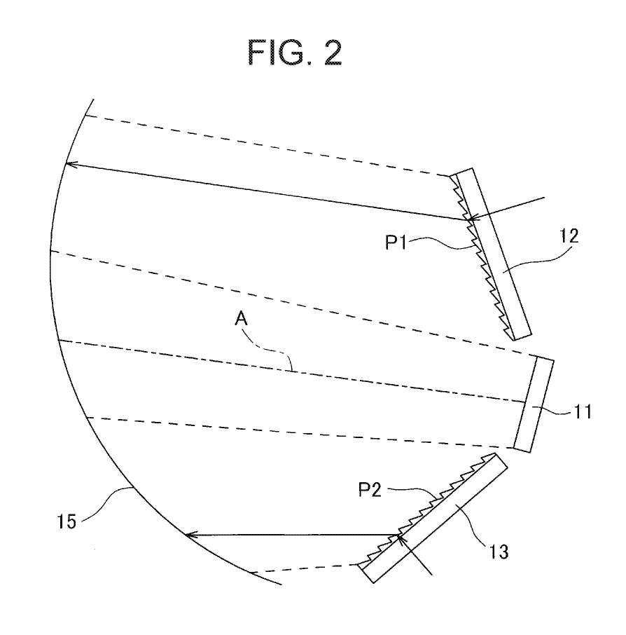

The downward-faced display 12 is configured of TFTLCD, for example, and displays thereon a video displayed as the lower virtual image V2 on the basis of a video signal, a synchronization signal, or the like input from the display control unit 16. The downward-faced display 12 is arranged above the front display 11 and closer to the aspherical mirror 17 to face the aspherical mirror 17. Further, the downward-faced display 12 is arranged to be obliquely tilted relative to the front display 11 so that it may face upward as it is farther away from the front display 11. As illustrated in FIG. 2, the entire face of the downward-faced display 12 is provided with a prism sheet P1 for refracting a display light of the downward-faced display 12 to be substantially parallel with the optical axis A of the front display 11.

The upward-faced display 13 is configured of TFTLCD (TFT liquid crystal display device), for example, and displays thereon a video displayed as the upper virtual image V3 on the basis of a video signal, a synchronization signal, or the like input from the display control unit 16. The upward-faced display 13 is arranged below the front display 11 and closer to the aspherical mirror 17 to face the aspherical mirror 17. Further, the upward-faced display 13 is arranged to be obliquely tilted relative to the front display 11 so that it may face downward as it is farther away from the front display 11. As illustrated in FIG. 2, the face of the upward-faced display 13 is provided with a prism sheet P2 for refracting a display light of the upward-faced display 13 to be substantially parallel with the optical axis A of the front display 11.

The front display 11, the downward-faced display 12, and the upward-faced display 13 may be configured of an EL (Electro Luminescence) display, screen and projector, or the like, not limited to TFTLCD.

The display control unit 16 generates videos displayed on the displays 11 to 13 and outputs them as video signals, synchronization signals, or the like on the basis of information input from a navigation device (not illustrated), a radar facing ahead of the vehicle, a camera for shooting a scene in front of the vehicle, or the like. The display control unit 16 is configured of a microcomputer incorporating a CPU (Central Processing Unit), a memory, and the like therein, or the like, for example.

The aspherical mirror 17 enlarges the videos displayed on the displays 11 to 13 and projects the enlarged videos on the windshield 3.

The windshield 3 is formed in a curved shape to curve vertically or horizontally depending on an outer diameter of the vehicle by use of laminated glass, IR (infrared ray) cut glass, UV (ultraviolet ray) cut glass, or the like. The windshield 3 transmits a line of sight of the driver inside the vehicle and reflects the videos projected from the HUD main body 2 in the sight direction.

In thus-configured HUD device 1, the front virtual image V1 is displayed across the windshield 3 on the line of sight of the passenger in front of the vehicle. The front virtual image V1 is formed at the same distance from the passenger in any of the upward, downward, right and left directions. To the contrary, the lower virtual image V2 is displayed below the front virtual image V1 and is formed to be closer to the passenger downward (=as it is farther away from the virtual image V1). Further, the upper virtual image V3 is displayed above the front virtual image V1 and is formed to be closer to the passenger upward (=as it is farther away from the front virtual image V1).

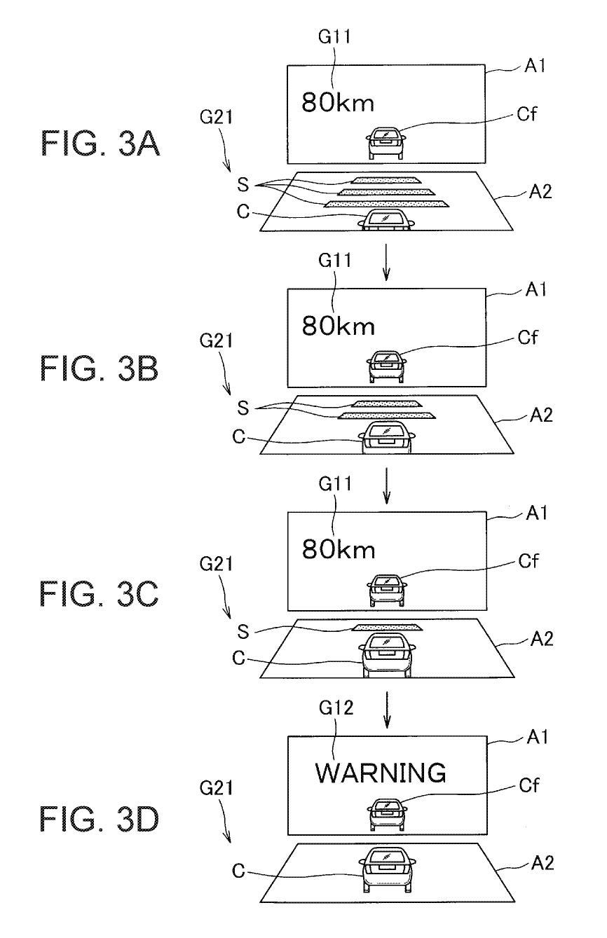

Exemplary video display in the HUD device 1 in the above configuration will be described first with reference to FIGS. 3A to 3D. In FIGS. 3A to 3D, Cf indicates an actual vehicle in front beyond the windshield 3. A1 indicates a front area in which the front virtual image V1 is displayed beyond the windshield 3, and A2 indicates a lower area in which the lower virtual image V2 is displayed beyond the windshield 3.

While the vehicle is traveling, the display control unit 16 finds a speed of the vehicle based on a measurement value from a speed sensor (not illustrated), and displays the found vehicle speed information G11 (=front display information) on the front display 11. Thereby, as illustrated in FIGS. 3A to 3C, the vehicle speed information G11 is visually confirmed as the front virtual image V1.

Further, when detecting a vehicle in front Cf on the basis of a measurement result by the radar facing ahead of the vehicle, the display control unit 16 displays inter-vehicle distance information G21 (=surrounding display information, lower display information) relative to the vehicle in front Cf on the downward-faced display 12. According to the present embodiment, the inter-vehicle distance information G21 including segments S depending on the inter-vehicle distance and a self-vehicle's image C at a position depending on the inter-vehicle distance is displayed. Thereby, as illustrated in FIGS. 3A to 3D, the segments S and the self-vehicle's image C are visually confirmed as the lower virtual image V2.

The segments S is displayed to be vertically arranged, and increases downward as the inter-vehicle distance is longer. The self-vehicle's image C is displayed below the segments S, and moves downward as the inter-vehicle distance is longer. Thereby, the passenger can intuitively grasp the inter-vehicle distance.

Further, when the inter-vehicle distance is at a predetermined value or less, the display control unit 16 displays alert information G12 (=front display information) on the front display 11. Thereby, as illustrated in FIG. 3D, the alert information G12 is visually confirmed as the front virtual image V1.

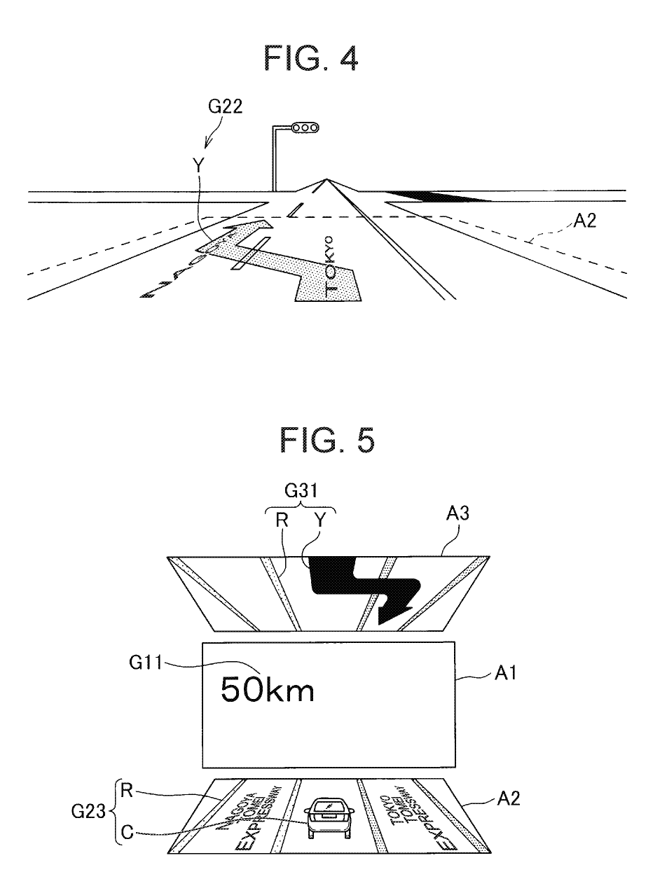

A description will be made below with reference to FIG. 4. A traffic light and roads illustrated in FIG. 4 indicate an actual traffic light and roads which can be seen beyond the windshield 3. As with FIGS. 3A to 3D, A2 indicates a lower area in which the lower virtual image V2 is displayed beyond the windshield 3.

When input with route guidance information from the navigation device (not illustrated), the display control unit 16 displays guidance information G22 (=surrounding display information, lower display information) on the downward-faced display 12. According to the present embodiment illustrated in FIG. 4, an arrow Y guiding from Tokyo to Nagoya is displayed as the guidance information G22. Thereby, the arrow Y is visually confirmed as the lower virtual image V2 as illustrated in FIG. 4.

The arrow Y is displayed to be superimposed on the actual lane for Tokyo and lane for Nagoya which are visually confirmed beyond the windshield 3. As described above, the lower virtual image V2 is formed to be closer to the passenger downward. Thus, in the example illustrated in FIG. 4, the arrow Y is visually confirmed as if it is drawn on the actual lanes.

A description will be made below with reference to FIG. 5. As with FIG. 3, A1 indicates a front area in which the front virtual image V1 is displayed beyond the windshield 3, A2 indicates a lower area in which the lower virtual image V2 is displayed beyond the windshield 3, and A3 indicates an upper area in which the upper virtual image V3 is visually confirmed beyond the windshield 3.

When input with route guidance information from the navigation device (not illustrated), the display control unit 16 displays traveling lane information G23 (=surrounding display information, lower display information) on the downward-faced display 12, and guidance information G31 (=surrounding display information, upper display information) on the upward-faced display 13. The display control unit 16 processes an image from the camera for shooting a scene in front to detect a lane in which the self-vehicle is traveling, and displays the detected traveling lane as the traveling lane information G23, for example. According to the present embodiment illustrated in FIG. 5, the traveling lane information G23 including a lane image R of a road in which the self-vehicle is currently traveling and the self-vehicle's image C superimposed on the lane in which the self-vehicle is traveling in the lane image R is displayed. Thereby, the lane image R and the self-vehicle's image C are visually confirmed as the lower virtual image V2 as illustrated in FIG. 5.

According to the present embodiment illustrated in FIG. 5, the guidance information G31 including the lane image R of a road in which the self-vehicle is currently traveling and the arrow Y superimposed on the lane image R is displayed. Thereby, as illustrated in FIG. 5, the lane image R and the arrow Y are visually confirmed as the upper virtual image V3. In this way, the traveling lane information G23 as the lower virtual image V2 and the guidance information G31 as the upper virtual image V3 are displayed thereby intuitively and easily notifying a situation around the vehicle, which contributes to safe driving.

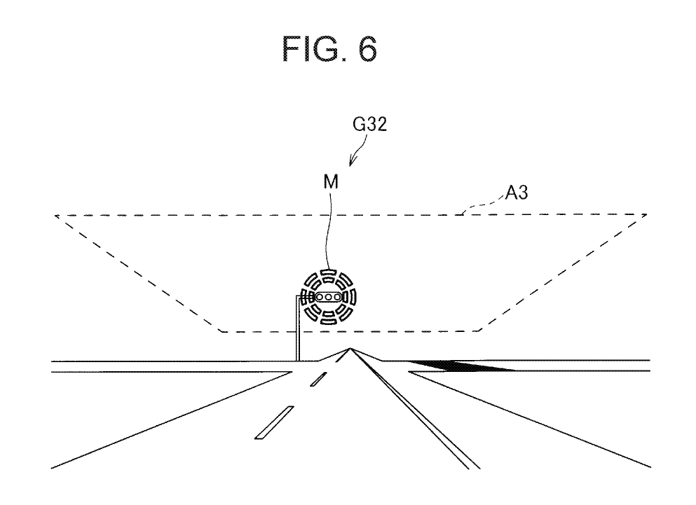

A description will be made below with reference to FIG. 6. A traffic light and roads illustrated in FIG. 6 indicate an actual traffic light and roads which can be seen beyond the windshield 3. The display control unit 16 processes an image from the camera for shooting a scene in front to detect an approaching object such as traffic light or road sign on the upper side of the shooting area, and then displays notification information G32 (=surrounding display information, upper display information) for notifying it on the upward-faced display 13, for example. According to the present embodiment illustrated in FIG. 6, a striking mark M superimposed on the approaching object such as actual traffic light or road sign is displayed as the notification information G32. Thereby, the striking mark M is visually confirmed as the upper virtual image V3 as illustrated in FIG. 6.

The segments S, the self-vehicle's image C, the arrow Y, and the lane image R displayed on the downward-faced display 12 and the upward-faced display 13 described above are drawn with one vanishing point (or in one-point perspective). Even if they are not drawn with one vanishing point, the downward-faced display 12 and the upward-faced display 13 are displayed to be obliquely tilted relative to the front display 11, and thus the lower virtual image V2 is formed to be closer to the passenger downward and the upper virtual image V3 is formed to be closer to the passenger upward so that they can be displayed to the passenger with a sense of depth.

With the HUD device 1 according to the first embodiment described above, the lower virtual image V2 displayed below the front virtual image V1 is formed to be closer to the passenger downward, and the upper virtual image V3 displayed above the front virtual image V1 is formed to be closer to the passenger upward. Thereby, a video with a sense of depth can be displayed.

Further, with the HUD device 1 according to the first embodiment described above, the downward-faced display 12 and the upward-faced display 13 are arranged above and below the front display 11. Thereby, the lower virtual image V2 closer to the passenger downward and the upper virtual image V3 closer to the passenger upward can be easily displayed.

Further, with the HUD device 1 according to the first embodiment described above, the downward-faced display 12 and the upward-faced display 13 are provided with the prisms P1 and P2 on their display faces, thereby enhancing luminance of the lower virtual image V2 and the upper virtual image V3.

According to the first embodiment described above, both the downward-faced display 12 and the upward-faced display 13 are provided to display the lower virtual image V2 and the upper virtual image V3 below and above the front virtual image V1, but the present invention is not limited thereto. Either the downward-faced display 12 or the upward-faced display 13 may be provided to display either the lower virtual image V2 or the upper virtual image V3.

### Second Embodiment

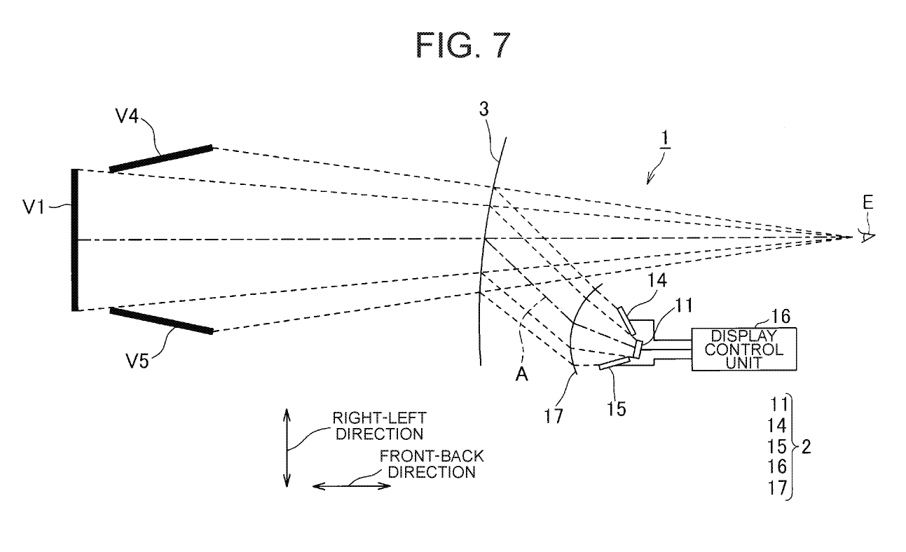

A second embodiment of the present invention will be described below with reference to FIG. 7 to FIG. 11. FIG. 7 is a configuration diagram of the HUD device as vehicle display device according to the second embodiment of the present invention. The illustrated same parts as in the HUD device 1 in FIG. 1 previously described according to the first embodiment are denoted with the same reference numerals, and a detailed description thereof will be omitted.

The HUD device 1 according to the second embodiment of the present invention includes the HUD main body 2 and the windshield 3 as illustrated in FIG. 7 as with the first embodiment. The front-back direction and the right-left direction of the vehicle according to the present embodiment are as indicated in FIG. 7.

The HUD main body 2 as display unit has the front display 11, a right display 14, a left display 15, the display control unit 16, and the aspherical mirror 17. The front display 11 is the same as in the first embodiment, and a detailed description thereof will be omitted herein.

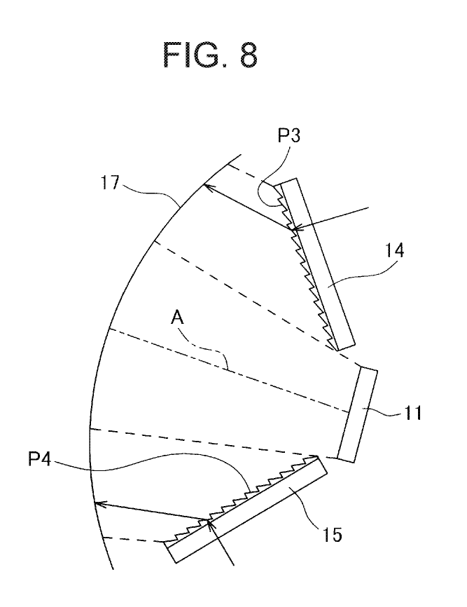

The right display 14 is configured of TFTLCD, for example, and displays thereon a video displayed as right virtual image V4 (=surrounding virtual image) on the basis of a video signal, a synchronization signal, or the like input from the display control unit 16. The right display 14 is arranged on the right side of the front display 11 and closer to the aspherical mirror 17 to face the aspherical mirror 17. Further, the right display 14 is arranged to be obliquely tilted relative to the front display 11 to face rightward as it is farther away from the front display 11. As illustrated in FIG. 8, the entire face of the right display 14 is provided with a prism sheet P3 for refracting a display light of the downward-faced display 12 to be substantially parallel with the optical axis A of the front display 11.

The left display 15 is configured of TFTLCD (TFT liquid crystal display device), for example, and displays thereon a video displayed as left virtual image V5 (=surrounding virtual image) on the basis of a video signal, a synchronization signal, or the like input from the display control unit 16. The left display 15 is arranged on the left side of the front display 11 and closer to the aspherical mirror 17 to face the aspherical mirror 17. Further, the left display 15 is arranged to be obliquely tilted relative to the front display 11 so that it may face leftward as it is farther away from the front display 11. As illustrated in FIG. 8, the face of the left display 15 is provided with a prism sheet P4 for refracting a display light of the left display 15 to be substantially parallel with the optical axis A of the front display 11.

The right display 14 and the left display 15 may be configured of an EL display, screen and projector, or the like, not limited to TFTLCD.

The display control unit 16 generates videos displayed on the displays 11, 14, and 15 on the basis of information input from the radar for detecting other vehicle traveling around the self-vehicle, the camera, or the like, for example, and outputs the videos as video signals, synchronization signals, or the like. The aspherical mirror 17 and the windshield 3 are the same as in the first embodiment, and thus a detailed description thereof will be omitted herein.

In thus-configured HUD device 1, the front virtual image V1 is displayed across the windshield 3 on a line of sight of the passenger in front of the vehicle. The front virtual image V1 is formed at the same distance from the passenger in any of the upward, downward, right, and left directions. To the contrary, the right virtual image V4 is displayed on the right side of the front virtual image V1 and is formed to be closer to the passenger rightward (=as it is farther away from the front virtual image V1). Further, the left virtual image V5 is formed on the left side of the front virtual image V1 and is formed to be closer to the passenger leftward (=as it is farther away from the front virtual image V1).

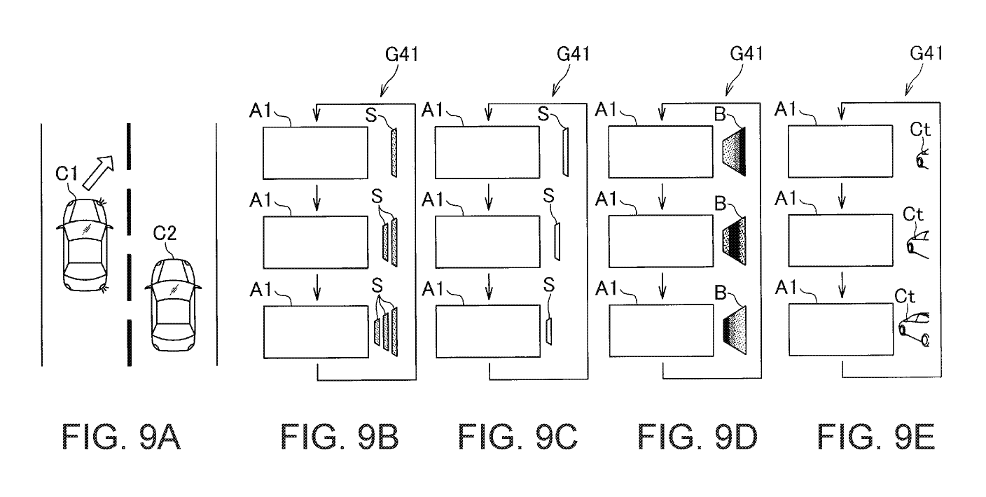

Exemplary video display in the HUD device 1 in the above configuration will be described first with reference to FIGS. 9A to 9E. In FIG. 9A, C1 indicates a self-vehicle, and C2 indicates a following vehicle which travel slightly behind the self-vehicle C1. As illustrated, when the driver (passenger) turns on right blinker to move to the right lane, the display control unit 16 detects whether a following vehicle is present in the right lane on the basis of a measurement result from the radar facing on the rear right side of the vehicle.

As illustrated in FIG. 9A, when a following vehicle C2 is present, the display control unit 16 displays notification information G41 (=surrounding display information, right display information) indicating the fact on the right display 14 as illustrated in FIGS. 9B to 9E. According to the present embodiment illustrated in FIG. 9, the notification information G41 including the segments S, a gradation bar B, and other vehicle's image Ct is displayed. Thereby, the segments S, the gradation bar B, and the other vehicle's image Ct are visually confirmed as the right virtual image V4 as illustrated in FIGS. 9B to 9E.

More specifically, in the example illustrated in FIG. 9B, the segments S are arranged in the right-left direction. The display control unit 16 lights the rightmost segment S and increases the number of segments S to be lit leftward. A maximum number of segments are lit, only the rightmost segment S is lit again, and the processing is repeatedly performed. In the example illustrated in FIG. 9C, the display control unit 16 displays a segment S on the rightmost part, and moves the segment S from right to left. Then, when the segment S is moved to the leftmost part, another segment S is displayed on the rightmost part again, and the processing is repeatedly performed.

In the examples of FIGS. 9B and 9C, the right virtual image V4 is formed to be closer to the passenger rightward as described below, and thus the segments S seem to be lit as if they flow from behind the vehicle ahead of the vehicle, and the fact that a following vehicle is present in the right lane can be intuitively notified to the passenger.

Further, in the example illustrated in FIG. 9D, the gradation bar B is arranged to extend in the right-left direction, and is displayed to be lighter in density as it is farther away from a dark color. The display control unit 16 moves the dark color on the gradation bar B from right to left. Then, when the dark color is moved to the leftmost part, it is moved to the rightmost part again, and the processing is repeatedly performed. In the example illustrated in FIG. 9E, the display control unit 16 displays the other vehicle's image Ct on the rightmost part, and moves it from right to left. Then, when it is moved to the leftmost part, it is moved to the rightmost part again, and the processing is repeatedly performed. Also in this case, the dark color or the other vehicle's image Ct seems to move from behind the vehicle ahead of the vehicle, and the fact that a following vehicle is present in the right lane can be intuitively notified to the passenger. When the gradation bar B can be displayed in colors, it can be displayed to gradually change from red for notifying a danger to orange for notifying an alert, and to blue for notifying safety.

The examples illustrated in FIGS. 9A to 9E describe the case in which the vehicle moves to the right lane, but when the vehicle moves to the left lane, the display control unit 16 displays the notification information G41 including the segments S, the gradation bar B, and the other vehicle's image Ct on the left display 15 when a following vehicle is present in the left lane. At this time, the segments S are sequentially lit from left to right, and a dark color indicating a danger in the gradation bar B moves from left to right, which are repeatedly performed. The other vehicle's image Ct is repeatedly moved from left to right.

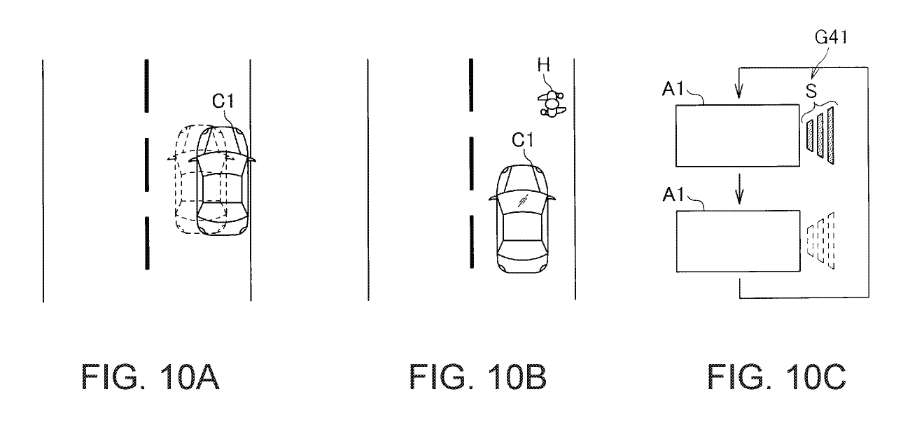

A description will be made below with reference to FIGS. 10A to 10C. The display control unit 16 detects deviation of the lane on the basis of an image from the camera for shooting a scene in front of the vehicle, for example. When detecting that the vehicle deviates to the right lane, the display control unit 16 then displays the notification information G41 indicating the fact (=surrounding display information, right display information) on the right display 14 as illustrated in FIG. 10A. In the example illustrated in FIGS. 10A to 10C, the segments S arranged in the right-left direction are blinked as the notification information G41 in the display control unit 16. Similarly, when detecting that the vehicle deviates to the left lane, the display control unit 16 displays the notification information indicating the fact (=surrounding display information, left display information) on the left display 15. In this way, the displays 14 and 15 for displaying the notification information G41 thereon are switched depending on a direction of deviation of the lane, and thus the passenger can intuitively grasp to which of the right and left lanes the vehicle deviates.

When processing an image from the camera for shooting a scene in front of the vehicle and detecting an approaching object such as pedestrian H on the right side of the shooting area, for example, the display control unit 16 displays the notification information G41 indicating the fact on the right display 14. As illustrated in FIG. 10B, when detecting an approaching object on the right side of the shooting area, the display control unit 16 displays the notification information G41 indicating the fact on the right display 14. Similarly, when detecting an approaching object on the left side of the shooting area, the display control unit 16 displays the notification information indicating the fact (=surrounding display information, left display information) on the left display 15. In this way, the displays 14 and 15 for displaying the notification information G41 thereon are switched depending on a direction in which an approaching object approaches, and thus the passenger can intuitively grasp in which of the right and left directions the approaching object approaches.

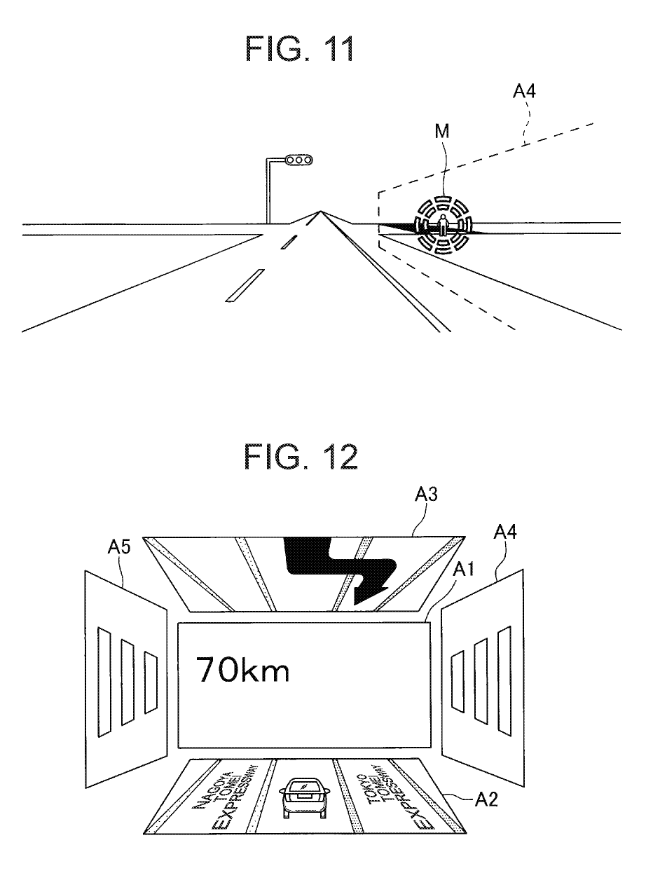

The segments S arranged in the right-left direction are displayed as the notification information G41 indicating that an approaching object is detected in the examples illustrated in FIGS. 10A to 10C, but a striking mark M surrounding an approaching object is displayed in the example illustrated in FIG. 11. A traffic light, roads, and a pedestrian illustrated in FIG. 11 indicate an actual traffic light, roads, and pedestrian which can be seen beyond the windshield 3.

The segments S, the gradation bar B, and the other vehicle's image Ct displayed on the right display 14 or the left display 15 are drawn with one vanishing point similarly as in the first embodiment. Even when they are not drawn with one vanishing point, the right display 14 and the left display 15 are displayed to be obliquely tilted relative to the front display 11, and thus the right virtual image V4 is formed to be closer to the passenger rightward and the left virtual image V5 is formed to be closer to the passenger leftward so that they can be displayed to the passenger with a sense of depth.

With the HUD device 1 according to the second embodiment described above, the right virtual image V3 displayed on the right side of the front virtual image V1 is formed to be closer to the passenger rightward, and the left virtual image V4 displayed on the left side of the front virtual image V1 is formed to be closer to the passenger leftward. Thereby, a display with a sense of depth can be conducted.

Further, with the HUD device 1 according to the second embodiment described above, the right display 14 and the left display 15 are arranged on the right and left sides of the front display 11, respectively. Thereby, the right virtual image V4 closer to the passenger rightward and the left virtual image V5 closer to the passenger leftward can be easily displayed.

Further, with the HUD device 1 according to the second embodiment described above, the right display 14 and the left display 15 are provided with the prism sheets P3 and P4 on their faces, respectively, thereby enhancing luminance of the right virtual image V4 and the left virtual image V5.

According to the second embodiment, both the right display 14 and the left display 15 are provided to display the right virtual image V4 and the left virtual image V5 on the right and left sides of the front virtual image V1, respectively, but the present invention is not limited thereto. Either the right display 14 or the left display 15 may be provided to display either the right virtual image V4 or the left virtual image V5.

Further, as illustrated in FIG. 12, the downward-faced, upward-faced, right and left displays 12 to 15 may be provided to display the lower, upper, right and left virtual images V2 to V5 around the front virtual image V1.

Further, according to the first and second embodiments described above, the downward-faced, upward-faced, right and left displays 12 to 15 are provided separately from the front display 11 to display the lower, upper, right, and left virtual images V2 to V5, respectively, but the present invention is not limited thereto. For example, a prism or the like may be provided in front of one display thereby to display the lower, upper, right and left virtual images V2 to V5.

### Third Embodiment

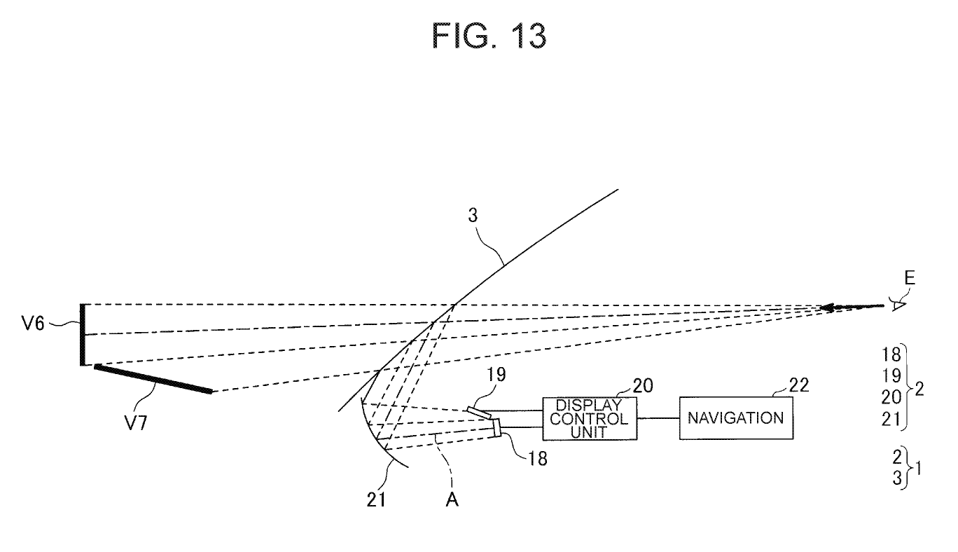

A third embodiment of the present invention will be described below with reference to FIG. 13 to FIG. 17. FIG. 13 is a configuration diagram (side view) of the headup display device as vehicle display device according to the third embodiment of the present invention. The illustrated same parts as in FIG. 1 described according to the first embodiment are denoted with the same reference numerals, and a detailed description thereof will be omitted.

The headup display (HUD) device 1 according to the third embodiment of the present invention is mounted on a vehicle such as automobile, and includes the HUD main body 2 and the windshield 3 as illustrated in FIG. 13.

The HUD main body 2 as display unit has a display 18, a display 19, a display control unit 20, and an aspherical mirror 21. The HUD main body 2 is housed near the lower end of the windshield 3 in the instrument panel of the vehicle. A video is projected from the projector toward the windshield 3, and is superimposed and visually confirmed on a scene in front of the vehicle visually confirmed beyond the windshield 3, and videos reflected on the windshield 3 and observed as virtual images V6 and V7 by the observer. Sign E in FIG. 13 indicates an eye point at a position of the eyes of the driver (observer).

The display 18 is configured of TFTLCD (TFT liquid crystal display device), for example, and displays thereon a video displayed as the virtual image V6 on the basis of a video signal, a synchronization signal, or the like input from the display control unit 20. Further, the display 18 is arranged such that the display face of the display 18 is vertical to the optical axis A.

The display 19 is configured of TFTLCD (TFT liquid crystal display device), for example, and displays thereon a video displayed as the virtual image V7 on the basis of a video signal, a synchronization signal, or the like input from the display control unit 20. Further, the display 19 is arranged to be tilted relative to the aspherical mirror 21 above the display 18, and the face of the display 19 is provided with a prism (not illustrated) for refracting a display light of the display 19 toward the aspherical mirror 21. The display 18 and the display 19 may be configured of an EL (Electro Luminescence) display, screen and projector, or the like, not limited to TFTLCD.

The display control unit 20 generates videos displayed on the display 18 and the display 19 on the basis of route guidance information input from a navigation device 22, and outputs the videos as video signals, synchronization signals, or the like. The display control unit 20 is configured of a microcomputer incorporating a CPU (Central Processing Unit), a memory, and the like therein, or the like, for example.

The aspherical mirror 21 enlarges the videos displayed on the display 18 and the display 19 and projects the enlarged videos on the windshield 3.

The windshield 3 is formed in a curved shape to curve vertically or horizontally depending on an outer diameter of the vehicle by use of laminated glass, IR (infrared ray) cut glass, UV (ultraviolet ray) cut glass, or the like. The windshield 3 transmits a line of sight of the driver inside the vehicle and reflects the videos projected from the HUD main body 2 in the eyesight direction.

In thus-configured HUD device 1, the virtual image V6 is displayed across the windshield 3 on a line of sight of the observer in front of the vehicle, and the virtual image V7 is displayed below the virtual image V6 to face the observer from the virtual image V6. That is, the virtual image V7 is closer to the observer downward. Thus, the virtual image V7 is displayed to cause the observer to feel a sense of depth.

The HUD device 1 is connected with the navigation device 22. As well known, the navigation device 22 has a means for acquiring a current position such as GPS (Global Positioning System) receiver, a storage means such as hard disk for storing map information therein, a display unit such as liquid crystal display for displaying a map, guidance information, or the like, and a control means such as CPU for searching a route from a current position to a set destination. It then searches a route to the destination, and guides the route on the basis of a current position of the self-vehicle. The navigation device 22 outputs information on a route to be guided as route guidance information to the display control unit 20.

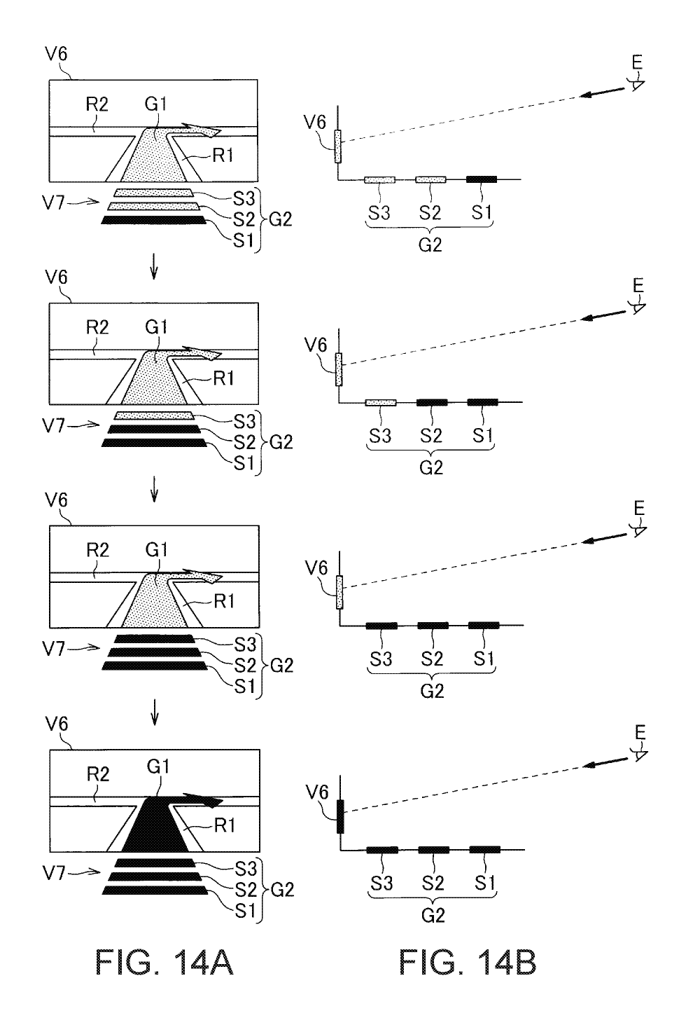

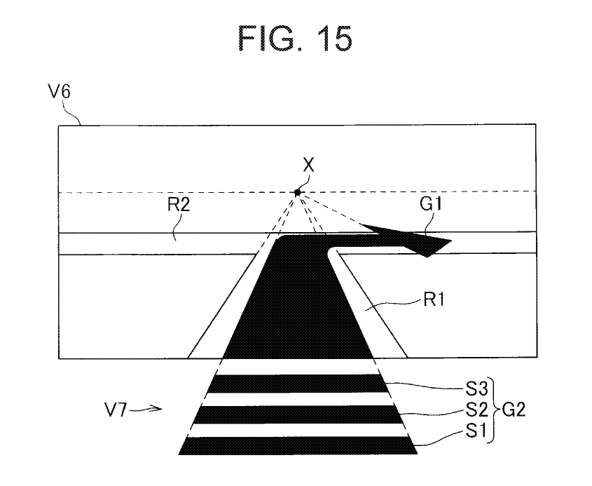

Video display in thus-configured HUD device 1 will be described below with reference to FIGS. 14A to 14B and FIG. 15. FIG. 14A and FIG. 14B schematically illustrate video display in the HUD device 1 with an arrow and a side view of the video display in the HUD device 1, respectively.

In FIGS. 14A and 14B, information R1 and R2 indicating roads are superimposed to be displayed on the virtual image V6, and information on a road indicated by a right turn arrow as first guidance information G1 is superimposed to be displayed on the information R1 and R2. Further, rectangular segments S1, S2, and S3 as second guidance information G2 are sterically displayed apart on the virtual image V7 (displayed to be closer to the observer downward).

The first guidance information G1 is farther than the second guidance information G2 as illustrated in FIG. 14A and the like.

The first guidance information G1 and the second guidance information G2 (the segments S1, S2, and S3) are di splayed (drawn) with one vanishing point (or in one-point perspective) as illustrated in FIG. 15. That is, the first guidance information G1 and the sides of the segments S1, S2, and S3 are drawn to cross at a vanishing point X. By doing so, a sense of mixture into the background can be enhanced, and the first guidance information G1 and the second guidance information G2 seem to the observer to be continuous. That is, the first guidance information G1 and the second guidance information G2 are displayed to be continuous as a series of information.

Further, in FIGS. 14A and 14B, the display is gradually emphasized from the segments S1, S2, and S3 toward the first guidance information G1. That is, the segment S1, the segments S1 and S2, the segments S1, S2, and S3, and the segments S1, S2, S3 and the first guidance information G1 are sequentially emphasized from the upper part toward the lower part in FIG. 14A. The display is emphasized by a change in luminance or color in the display 18 or the display 19, for example.

The emphasized display changes on the basis of a position of the vehicle mounting the HUD device 1 thereon. That is, the route guidance information input from the navigation device 22 includes self-vehicle's current position information. Alternatively, a distance may be acquired from a point where right turn or left turn guidance is conducted instead of a current position. The display control unit 20 may then determine an image (the first guidance information G1 and the segments S1, S2, S3) to be emphasized on the basis of current position information or a distance from a point to conduct guidance.

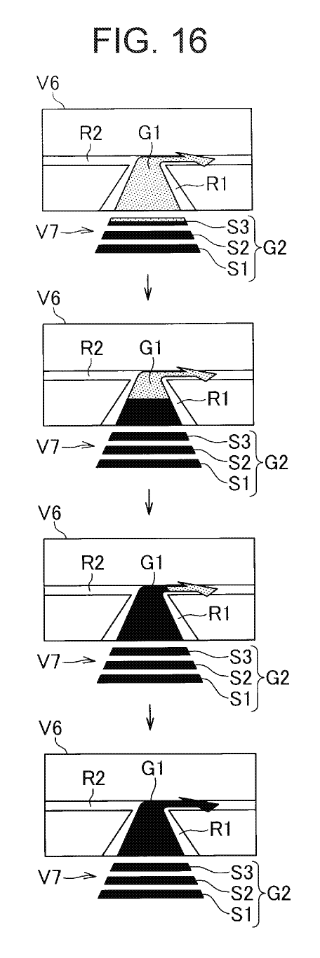

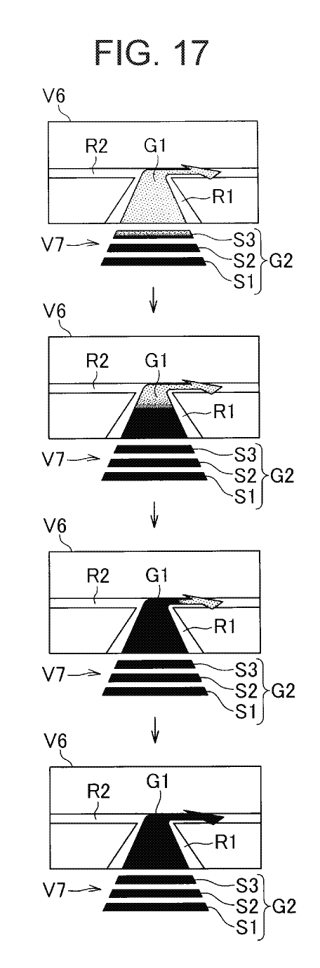

The change in emphasized display is not limited in units of guidance information as illustrated in FIGS. 14A and 14B. The first guidance information G1 or the segments S1, S2, S3 may be divided into a plurality of parts to be changed as illustrated in FIG. 16. Alternatively, a boundary between an emphasized part and a non-emphasized part may be gradationally displayed as illustrated in FIG. 17. That is, the number of divided parts to be gradually changed may be increased. By doing so, the changes in emphasized display between the items of guidance information seem to be smooth.

According to the present embodiment, the HUD device 1 has the HUD main body 2 for displaying the first guidance information G1 as the first virtual image V6 and displaying the second guidance information as the second virtual image V7 below the first virtual image V6 to be closer to the observer downward. Thus, the information in the front-back direction of the vehicle can be displayed on the second guidance information G2, thereby achieving a sense of distance in the front-back direction together with a sense of depth. Further, the first guidance information G1 and the second guidance information G2 are displayed to be continuous with one vanishing point, thereby guiding a route intuitive and easy to understand. Thus, it can contribute to safer driving.

The emphasized display gradually changes from the second guidance information G2 to the first guidance information G1, thereby guiding a route with traveling direction emphasized to gradually advance. Further, guidance may be conducted by changing the display depending on a position of the vehicle, for example.

According to the embodiment described above, the display 18 and the display 19 are provided for displaying the first guidance information and the second guidance information, respectively, but one display may be configured to be divided into apart to display the first guidance information and apart to display the second guidance information. In this case, the part to display the second guidance information is refracted toward the aspherical mirror 21 via a prism, lens, or the like, thereby obtaining the same effect as being obliquely tilted.

### Fourth Embodiment

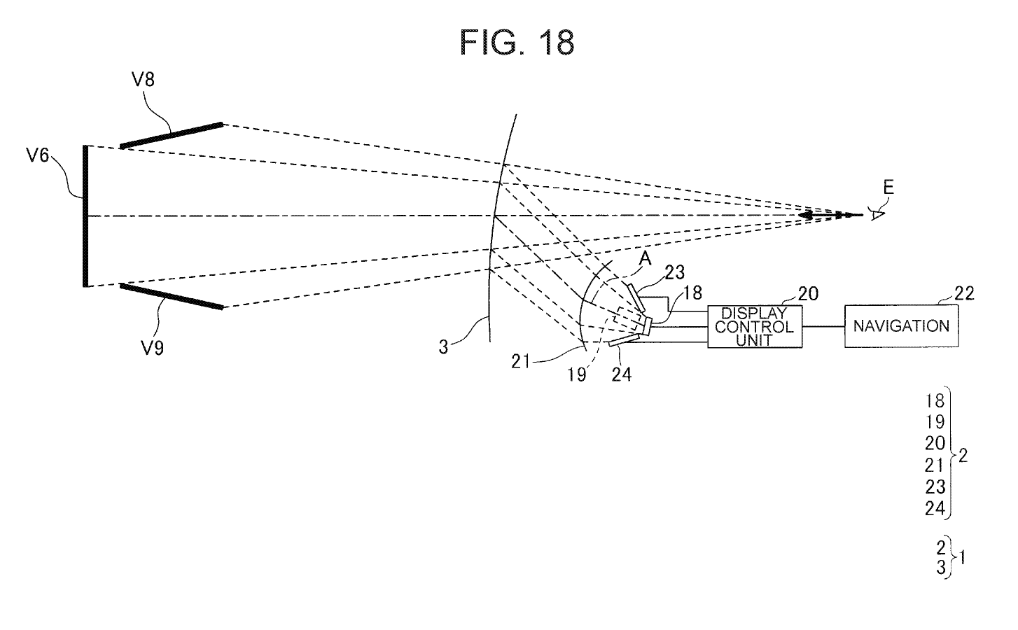

A fourth embodiment of the present invention will be described below with reference to FIG. 18 to FIG. 21. The same parts as in the third embodiment described above are denoted with the same reference numerals, and a description thereof will be omitted. FIG. 18 is a configuration diagram (top view) of the headup display device as vehicle display device according to the fourth embodiment of the present invention.

The headup display (HUD) device 1 according to the fourth embodiment of the present invention includes the HUD main body 2 and the windshield 3 as illustrated in FIG. 18.

The HUD main body 2 as display unit according to the present embodiment has the configuration of the third embodiment added with a display 23 and a display 24.

The display 23 is configured of TFTLCD (TFT liquid crystal display device), for example, and displays thereon a video displayed as virtual image V8 corresponding to the third virtual image on the basis of a video signal, a synchronization signal, or the like input from the display control unit 20. Further, the display 23 is arranged on the right side of the display 18 to be obliquely tilted relative to the aspherical mirror 21, and the face of the display 23 is provided with a prism (not illustrated) for refracting a display light of the display 19 toward the aspherical mirror 21.

The display 24 is configured of TFTLCD (TFT liquid crystal display device), for example, and displays thereon a video displayed as virtual image V9 corresponding to the third virtual image on the basis of a video signal, a synchronization signal, or the like input from the display control unit 20. Further, the display 24 is arranged on the left side of the display 18 to be tilted toward the aspherical mirror 21, and the face of the display 24 is provided with a prism (not illustrated) for refracting a display light of the display 24 toward the aspherical mirror 21.

In the HUD device 1 according to the present embodiment, the virtual image V8 can be displayed on the right side of the virtual image V6 and the virtual image V9 can be displayed on the left side of the virtual image V6 in addition to the virtual image V6 and the virtual image V7 (not illustrated in FIG. 18). The virtual image V8 is displayed to be closer to the observer rightward. The virtual image V9 is displayed to be closer to the observer leftward. Thus, the virtual image V8 and the virtual V9 are displayed to cause the observer to feel a sense of depth.

According to the present embodiment, either the virtual image V8 or the virtual image V9 is displayed depending on whether the route guidance information is for right turn or left turn. That is, the virtual image V8 is displayed for right turn and the virtual image V9 is displayed for left turn.

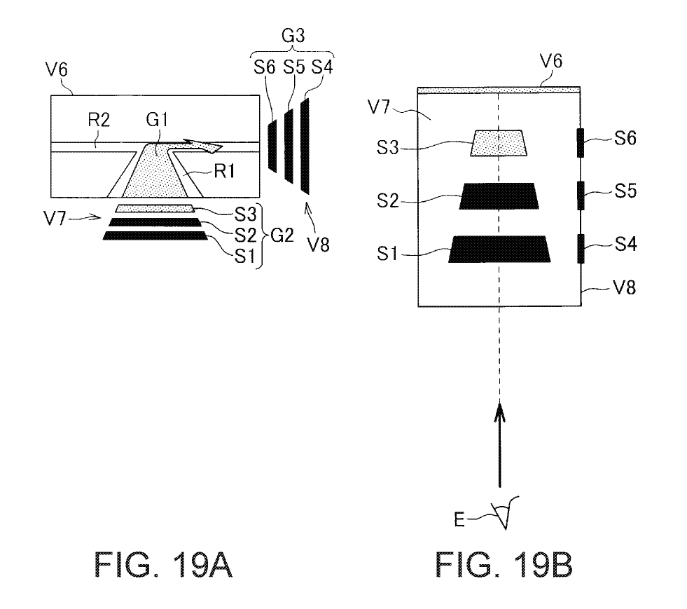

FIGS. 19A and 19B illustrate exemplary display according to the present embodiment. FIGS. 19A and 19B schematically illustrate a diagram with an arrow and a top view, respectively. FIGS. 19A and 19B illustrate an example for right turn, and thus third guidance information G3 is displayed in the virtual image V8. The example is the same as the case for left turn except that the third guidance information G3 is displayed in the virtual image V9. Further, in FIGS. 19A and 19B, the virtual image V6 and the virtual image V7 are the same as in the third embodiment.

In FIG. 19A, rectangular segments S4, S5, and S6 are sterically displayed apart as the third guidance information G3 in the virtual image V8 (displayed to cause the observer to feel closer to him/her rightward). The third guidance information G3 (the segments S4, S5, and S6) may be displayed (drawn) with one vanishing point.

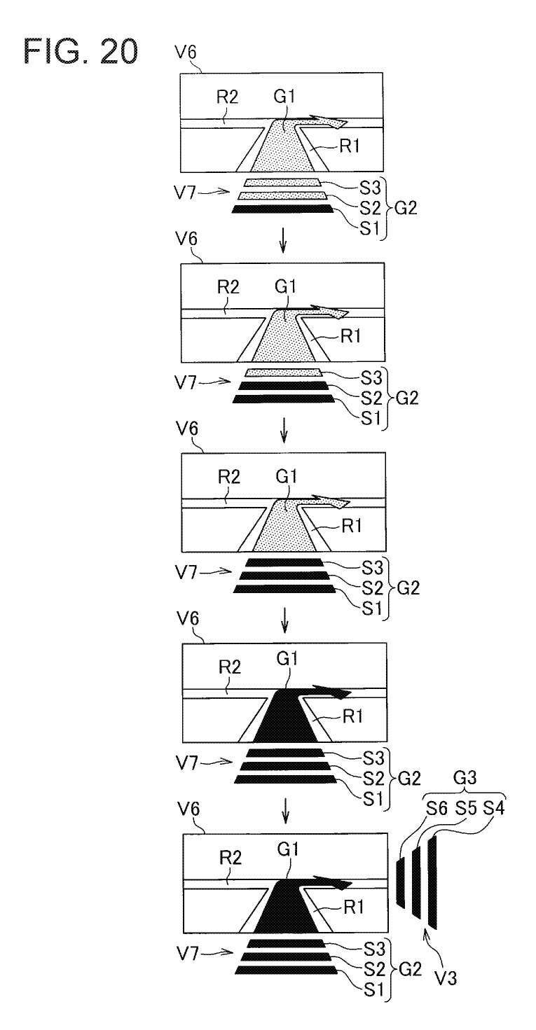

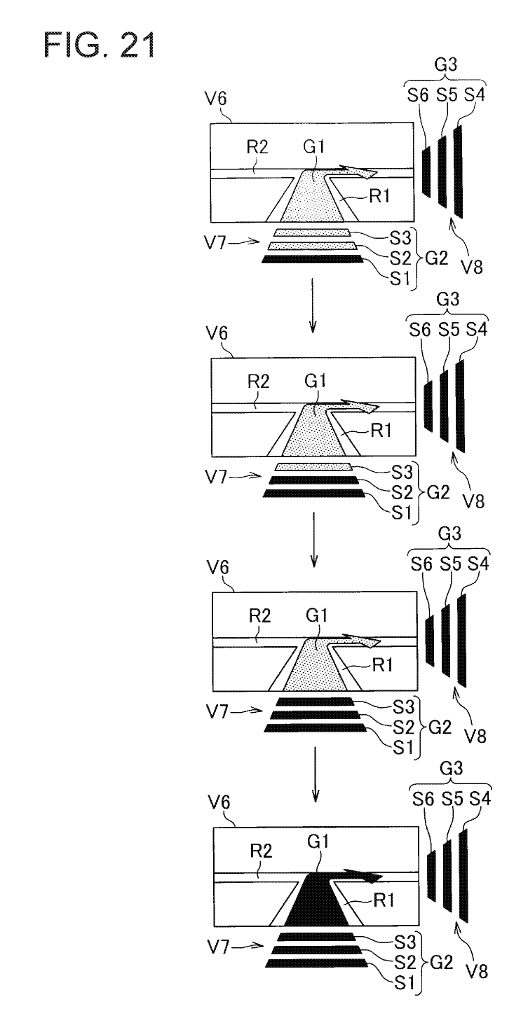

Further, the third guidance information G3 may be displayed immediately before the right turn point as illustrated in FIG. 20, or may be always displayed until the completion of right turn after the route guidance information is displayed (after the second guidance information G2 starts being displayed) as illustrated in FIG. 21.

Further, the third guidance information G3 may be displayed to be gradually emphasized like the second guidance information G2.

According to the present embodiment, the third guidance information G3 is displayed on the right side of the first guidance information G1 when the first guidance information G1 is for right turn of the vehicle, and is displayed on the left side of the first guidance information G1 when the first guidance information G1 is for left turn of the vehicle, thereby further emphasizing left turn or right turn guidance.

Further, the third guidance information G3 displayed on right turn is displayed to be closer to the observer rightward, and the right turn can be further emphasized in the traveling direction.

According to the embodiment described above, the display 18, the display 23, and the display 24 are provided for displaying the first guidance information and the third guidance information, but one display may be configured to be divided into a part to display the first guidance information and a part to display the third guidance information. In this case, the part to display the third guidance information is refracted toward the aspherical mirror 21 via a prism, lens, or the like, thereby obtaining the same effect as being tilted. The second guidance information may be also included in one display.

Fifth to ninth embodiments of the present invention will be described below with reference to the drawings. The same components as the components described according to the fifth embodiment and the components having the similar functions thereto in the sixth to ninth embodiments are denoted with the same reference numerals as in the fifth embodiment, and a description thereof will be omitted.

### Fifth Embodiment

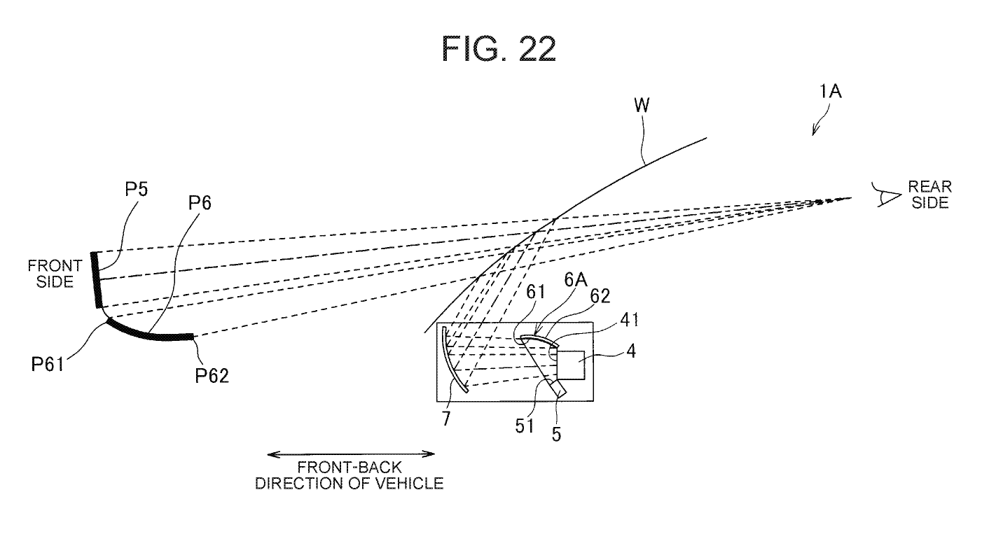

A vehicle display device 1A according to the present embodiment includes a display 4, a projector 5, a screen 6A, and a reflective member 7, and is arranged in the instrument panel of the vehicle to form a virtual image indicating a road situation or vehicle state in front of a windshield W as illustrated in FIG. 22. The virtual image is configured of a main image P5 and a sub-image P6 described below.

The display 4 is TFTLCD (TFT liquid crystal display device), for example, and is provided behind the reflective member 7. The display 4 is configured such that an image is displayed on a display face 41 faced in front thereby to form the main image P5 along the plane substantially orthogonal to the front-back direction of the vehicle (or opposed to the passenger).

The projector 5 is a liquid crystal projector, for example, is provided behind the reflective member 7 and below the display 4, and is configured to project a light from a projection face 51 faced obliquely upward (in front and above) onto the screen 6A.

The screen 6A is a reflective screen, opposes the projector 5 with a front face 61 faced downward, and has a convex-curved part 62 (or concave as viewed from the projector 5) upward to be entirely formed in a curved shape. An image is formed on the front face 61 of the screen 6A by a light projected by the projector 5, and the sub-image P6 is formed by the image. The sub-image P6 is such that one end P61 is adjacent to the lower end of the main image P5 and the other end P62 is positioned closer to the rear side than the end P61 (closer to the observer) to be convex-curved downward (or concave as viewed from the main image P5) since the screen 6A has the curved part 62.

The reflective member 7 is a convex aspherical mirror entirely facing in front, for example, and is configured to reflect a light irradiated from behind toward the windshield W obliquely above (upward and behind).

Exemplary display information on the main image P5 formed by the display 4 and the sub-image P6 formed by the projector 5 and the screen 6A will be described.

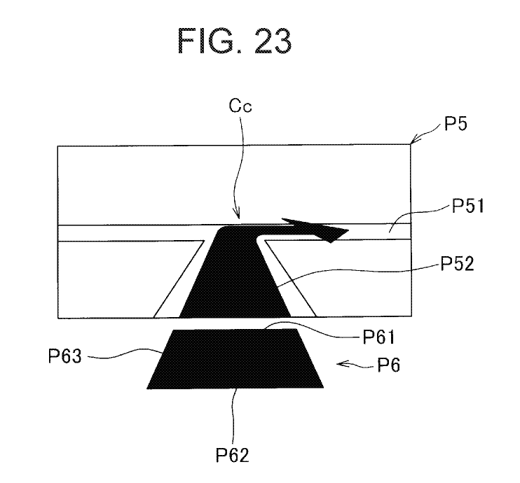

The main image P5 and the sub-image P6 are displayed in association with a car navigation system, where the main image P5 has a road display part P51 for displaying shapes of roads, surrounding buildings, and the like and a guidance display part P52 as arrow for guiding a traveling direction of the vehicle, and the sub-image P6 has a guidance display part P63 as illustrated in FIG. 23. The guidance display part P63 viewed from the passenger approaches the main image P5 also in the vertical direction as it extends from the end P62 toward the end P61 in front, and is connected to the guidance display part P52 apart. Thus, the main image P5 displayed beyond the sub-image P6 is recognized with its lower side as closer to the observer and its upper side as in front so that the main image P5 and the sub-image P6 may be combined to be sterically displayed. At this time, the sub-image P6 is downward-convex curved, and thus the guidance display part P63 is smoothly connected to the guidance display part P52.

As illustrated in FIG. 23, when the guidance display parts P52 and P63 indicate right turn at the intersection Cc, as the vehicle approaches the intersection Cc, the guidance display part P63 of the sub-image P6 is gradually hidden from the end P62 to be shorter in the front-back direction and the road display part P51 entirely moves downward thereby to cause the observer to easily feel the vehicle's approach to the intersection Cc.

According to the present embodiment, the following effect can be obtained. That is, the sub-image P6 is formed by the screen 6A having the curved part 62 and the guidance display part P63 is smoothly connected to the guidance display part P52, thereby displaying a sense of unity of the main image P5 and the sub-image P6 and enhancing a sense of three-dimensionality.

Further, when the sub-image is formed by a display as conventionally, the display needs to be provided with a heat radiating member such as heat sink but the screen 6A does not require a heat radiating member so that the screen 6A may require a small installation space, thereby downsizing the entire vehicle display device.

### Sixth Embodiment

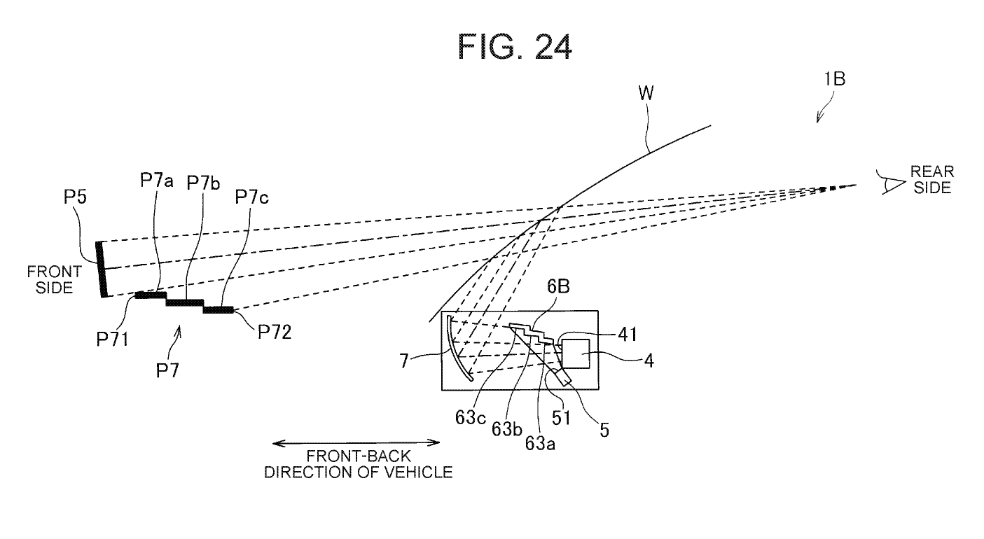

A vehicle display device 1B according to the present embodiment includes the display 4, the projector 5, a screen 6B, and the reflective member 7 as illustrated in FIG. 24.

The screen 6B is a reflective screen, is arranged similarly as in the fifth embodiment, and has three reflective faces 63a to 63c different in distance from the projector 5 to be formed in a stepped manner. The reflective faces 63a to 63c are arranged to be longer in distance from the projector 5 from the reflective face 63a closest to the rear side toward the reflective face 63c closest to the front side.

A sub-image P7 relayed by the screen 6B has the following shape. That is, the sub-image P7 has three display faces P7a to P7c arranged in the front-back direction, and the display faces closer to an end P71 are arranged to be closer to the main image P5 in the vertical direction. The sub-image P7 has a guidance display part as in the fifth embodiment, for example, and is configured such that one display face corresponds to a predetermined distance (100 m, for example) and the display faces are sequentially turned off from the rear side as the vehicle approaches the destination.

According to the present embodiment, the following effect can be obtained. That is, the sub-image P7 is formed by the screen 6B having the three reflective faces 63a to 63c and is combined with the main image P5 so that the display faces closer to the front side of the sub-image P7 may be formed to be closer to the main image P5 in the vertical direction, thereby displaying continuity between the sub-image P7 and the main image P5 and enhancing a sense of three-dimensionality.

### Seventh Embodiment

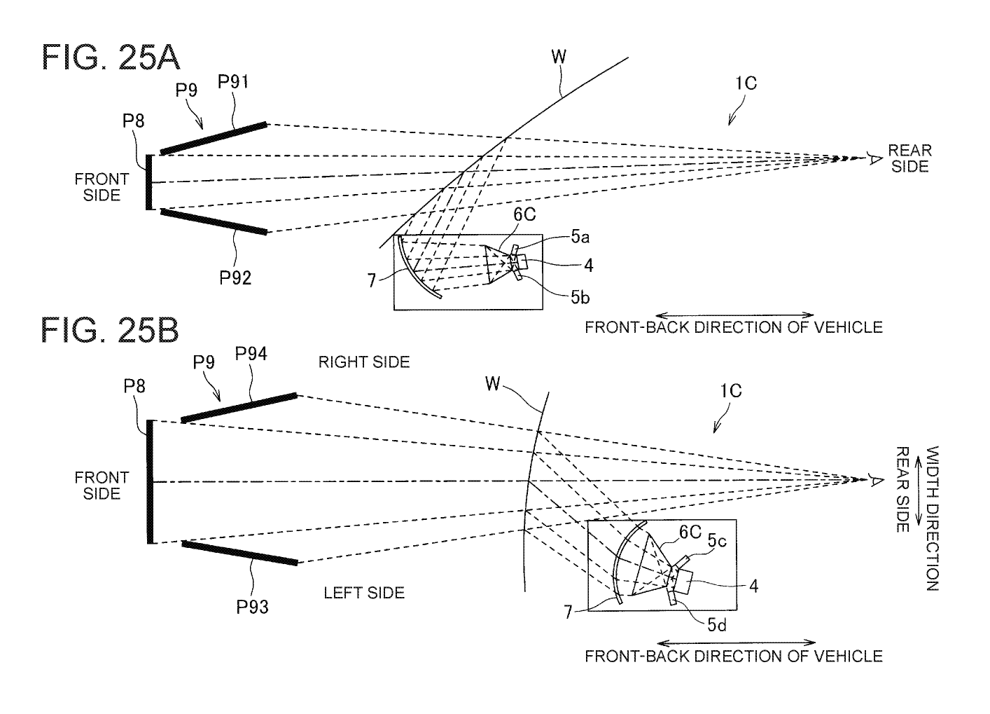

A vehicle display device 1C according to the present embodiment includes the display 4, four projectors 5a to 5d, a screen 6C, and the reflective member 7 as illustrated in FIGS. 25A and 25B.

The four projectors 5a to 5d include the upper projector 5a arranged above the display 4, the lower projector 5b arranged below the display 4, the left-faced projector 5c arranged on the right side of the display 4, and the right-faced projector 5d arranged on the left side of the display 4.

The screen 6C is a reflective screen which is formed in a tubular shape having a larger opening from the projectors 5a to 5d toward the reflective member 7, an outer peripheral face of which is formed in a shape with a vertex and its surroundings of the cone removed and the inside of which is a reflective face.

A sub-image P9 formed by the projectors 5a to 5d and the screen 6C will be described below. A sub-image upper face P91 is formed above a main image P8 by the upper projector 5a, a sub-image lower face P92 is formed below the main image P8 by the lower projector 5b, a sub-image left face P93 is formed on the left side of the main image P8 by the left-faced projector 5c, a sub-image right face P94 is formed on the right side of the main image P8 by the right-faced projector 5d, and the sub-image P9 is configured of the faces P91 to P94. That is, the sub-image P9 is displayed to surround the main image P8.

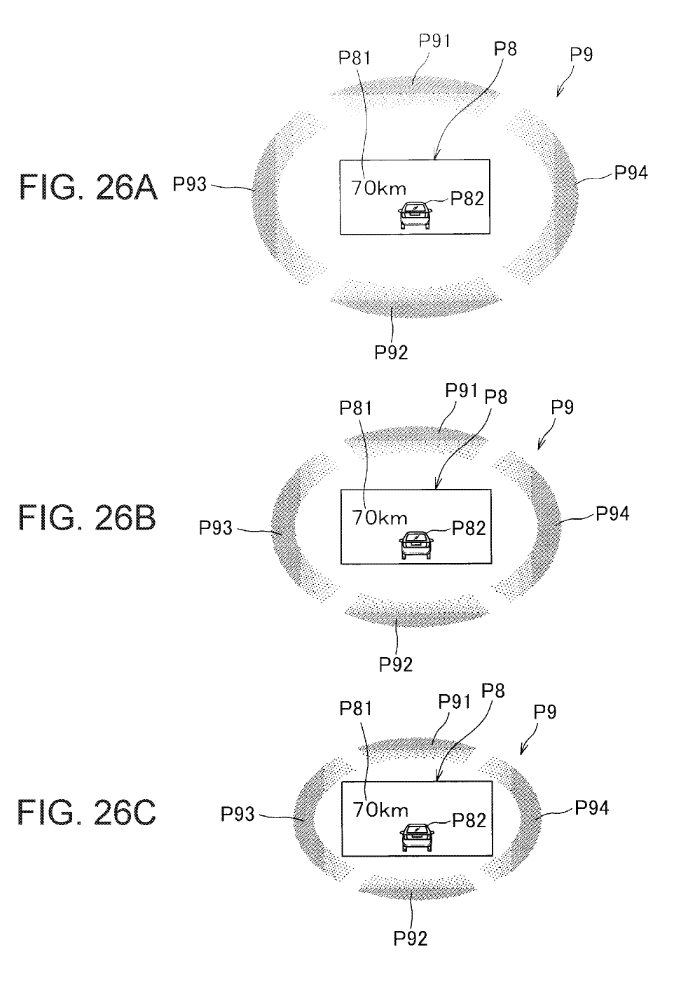

Exemplary display information of the main image P8 and the sub-image P9 will be described below. The main image P8 and the sub-image P9 display a situation to approach a vehicle in front as illustrated in FIGS. 26A to 26C, and the main image P8 has a speed display part P81 for displaying a current speed of the self-vehicle and a forward vehicle display part P82 for displaying the presence of a vehicle in front.

The sub-image P9 changes its display position depending on a degree of approach between the self-vehicle and a vehicle in front as illustrated in FIGS. 26A to 26C. That is, when the self-vehicle is relatively distant from the vehicle in front, the sub-image P9 is displayed away from the main image P8 as illustrated in FIG. 26A, and when the self-vehicle approaches the vehicle in front, the sub-image P9 is displayed near the main image P8 as illustrated in FIG. 26C.

According to the present embodiment, the following effect can be obtained. That is, the sub-image P9 formed by the tubular screen 6C surrounds the main image P8 thereby to emphasize the main image P8 and to enhance a sense of three-dimensionality.

Further, a display position of the sub-image P9 is changed depending on a degree of approach to the vehicle in front, and thus the passenger can intuitively and easily understand the approach to the vehicle in front, thereby decelerating and keeping an appropriate inter-vehicle distance.

### Eighth Embodiment

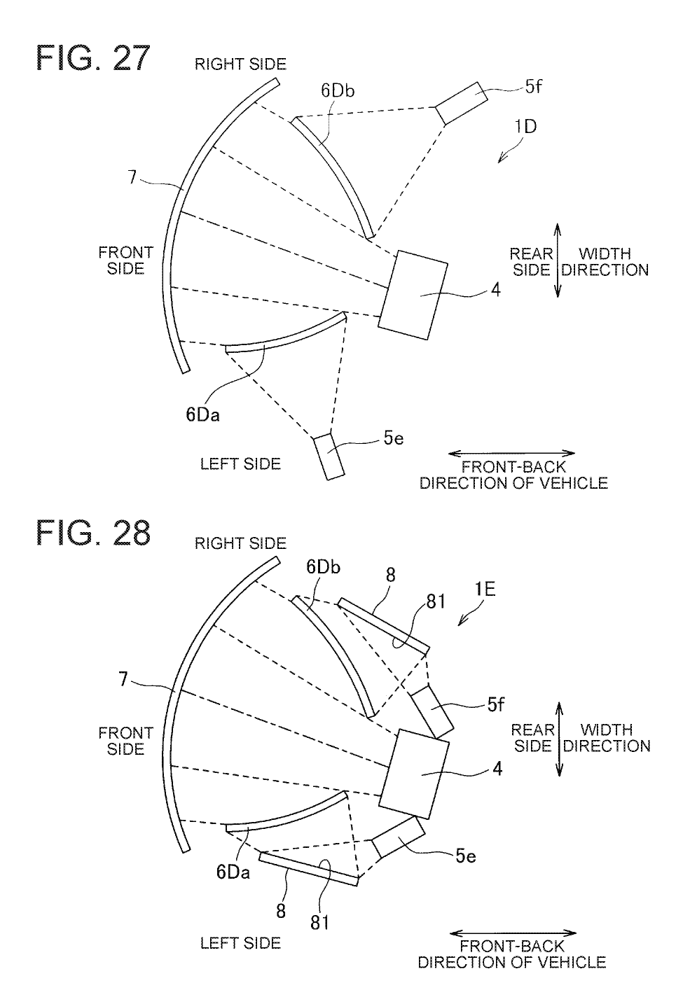

A vehicle display device 1D according to the present embodiment includes the display 4, two projectors 5e, 5f, two screens 6 Da, 6Db, and the reflective member 7 as illustrated in FIG. 27.

The two projectors 5e and 5f are the left projector 5e and the right projector 5f, and are arranged behind the screens 6 Da and 6Db, respectively (opposite to the reflective member 7).

The two screens 6 Da and 6Db are the left screen 6 Da and the right screen 6Db. The screens 6 Da and 6Db are transmissive screens for rear projection, and are entirely formed to be convex-curved toward their backside.

A sub-image (not illustrated) is formed on the left side of a main image (not illustrated) by the left projector 5e and the left screen 6 Da, a sub-image (not illustrated) is formed on the right side of the main image by the right projector 5f and the right screen 6Db, and the sub-images are curved similarly to the sub-image P6 according to the fifth embodiment.

According to the present embodiment, the following effect can be obtained. That is, the projectors 5e and 5f are arranged behind the screens 6 Da and 6Db, respectively, thereby simplifying the configuration for the reflective member 7 around the display 4.

### Ninth Embodiment

A vehicle display device 1E according to the present embodiment includes the display 4, the two projectors 5e, 5f, the two screens 6 Da, 6Db, the reflective member 7, and two second reflective members 8 as illustrated in FIG. 28.

The two second reflective members 8 are plane mirrors, for example, and are arranged behind the screens 6 Da and 6Db, respectively, and their reflective faces 81 are faced to the back of the screens 6 Da and 6Db thereby to reflect the lights projected by the projectors 5e and 5f toward the back of the screens 6 Da and 6Db, respectively.

The projectors 5e and 5f are arranged near the display 4 and are configured to project a light toward the second reflective members 8.

According to the present embodiment, the following effect can be obtained. That is, the second reflective members 8 for reflecting a light projected by the projectors 5e and 5f toward the screens 6 Da and 6Db are provided thereby to enhance a degree of freedom of arrangement of the projectors 5e and 5f, and the projectors 5e and 5f are arranged near the display 4 thereby to downsize the entire vehicle display device 1E.

The present invention is not limited to the fifth to ninth embodiments, and the present invention encompasses other configurations capable of achieving the object of the present invention, and variants described below.

For example, the screen 6A has the curved part 62 according to the fifth embodiment, the screen 6B has the reflective faces 63a to 63c according to the sixth embodiment, the screen 6C is formed in a tubular shape according to the seventh embodiment, and the configurations may be combined as needed. That is, a screen may have a curved part and a stepped part, for example, or a tubular screen may be formed with a stepped part or curved part. Further, a transmissive screen may have a curved part, a stepped part, or the like to be formed in an appropriate shape.

Further, the above embodiments are merely representative forms of the present invention, and the present invention is not limited to the embodiments. That is, the embodiments may be variously modified and accomplished without departing from the spirit of the present invention.

### REFERENCE SIGNS LIST

1 HUD device (vehicle display device)
2 HUD main body (display unit)
11 Front display
12 Downward-faced display
13 Upward-faced display
14 Right display
15 Left display
V1 Front virtual image
V2 Lower virtual image (surrounding virtual image)
V3 Upper virtual image (surrounding virtual image)
V4 Right virtual image (surrounding virtual image)
V5 Left virtual image (surrounding virtual image)
G11 Vehicle speed information (front display information)
G12 Alert information (front display information)
G21 Inver-vehicle distance information (surrounding display information, lower display information)
G22 Guidance information (surrounding display information, lower display information)
G23 Traveling lane information (surrounding display information, lower display information)
G31 Guidance information (surrounding display information, lower display information)
G32 Notification information (surrounding display information, upper display information)
G41 Notification information (surrounding display information, right display information)

1. A vehicle display device comprising:
a display unit for displaying front display information formed as front virtual image on a line of sight of a passenger and upper display information formed as upper virtual image on a upper side of the front virtual image,
wherein the upper virtual image is formed to be closer to the passenger toward the upper side,
the display unit has a front display for displaying the front display information and an upward-faced display for displaying the upper display information, and
the upward-faced display is arranged below the front display.

2. A vehicle display device comprising:
a display unit for displaying front display information formed as front virtual image on a line of sight of a passenger and right display information formed as right virtual image on a right side of the front virtual image or left display information formed as left virtual image on a left side of the front virtual image,
wherein the right virtual image is formed to be closer to the passenger toward the right side, or the left virtual image is formed to be closer to the passenger toward the left side,
the front virtual image is formed farther than the right virtual image or the left virtual image, and
the display unit has a front display for displaying the front display information and a right display for displaying the right display information or a left display for displaying the left display information.
